(19) United States
(12) Patent Application Publication
(10) Pub. No.: US 2007/0026875 A1
(43) Pub. Date: Feb. 1, 2007

(54) Message proxy notifying method and device

(75) Inventors: Yuji Nomura, Kawasaki (JP); Takamitsu Iida, Kawasaki (JP)

Correspondence Address: BINGHAM MCCUTCHEN LLP, 3000 K STREET, NW, BOX IP, WASHINGTON, DC, 20007, US

(73) Assignee: Fujitsu Limited

(21) Appl. No.: 11/261,571

(22) Filed: Oct. 31, 2005

(30) Foreign Application Priority Data
Jul. 29, 2005 (JP) 2005-220564

(51) Int. Cl. H04Q 7/20

(52) U.S. Cl. 455/458

(57) ABSTRACT

In a method and a device by which a service user can receive an event notifying message without disclosing contact information to an event notifier, a combination of a message ID acquired from a message receiver having received from a proxy request device an offering of the message ID using a unique code or symbol by which a destination can not be specified and contact information of the receiver is held, and an event notifying message corresponding to the message ID is transmitted to the message receiver of the contact information having the combination with the message ID when the message ID is received from the proxy request device, with an occurrence of an event. When the receiver receives the offering of the message ID and the message ID is received from the proxy request device having acquired the message ID from the receiver with an occurrence of an event, an event notifying message corresponding to the message ID is also transmitted. Furthermore, when the message ID is received from the proxy request device having read the message ID attached to a human body or an object, an event notifying message corresponding to the message ID is also transmitted.

### BACKGROUND OF THE INVENTION

1. Field of the Invention

The present invention relates to a message proxy (agent, deputy, or substitute) notifying method and device, and in particular to a method and device by which an event notifier transmits an event notifying message of a service to a service user.

2. Description of the Related Art

As cases using an event notifying message (hereinafter, occasionally referred to simply as a message) as mentioned above, the followings have been mentioned:

A case where a telephone No. of a mobile telephone of a service user is notified to a restaurant that is a service offerer (event notifier) when the service user waits for a seat available in the restaurant, and an event notifying message indicating that an available seat is now prepared is notified to the service user from the restaurant by e-mail, telephone, or the like;

A case where a piece of paper on which a contact address, etc. of an owner who is a service user is written is attached to his/her belongings as measures against a lost article, and when the belongings are lost, an event notifying message indicating that the lost article is now found is notified to the owner from a finder (contact place) who is an event notifier by e-mail, telephone, or the like; and

A case where a tag on which a contact address, etc. of a parent who is a service user is written is previously provided to his/her child as measures against a lost child, and an event notifying message indicating that the lost child is now found is notified to the parent from a finder (contact place) who is an event notifier having found his/her lost child by e-mail, telephone, or the like.

Thus, in any case, a mail address or a telephone No. which is contact information for a message receiver has been preliminarily notified to a message transmitter.

Also, there are a voice message collection system and a voice message collection server by which a WWW server presents a voice message board HP, a URL thereof is notified to a message input person, a voice message input telephone No. and ID No. are presented if the HP is referred, and the ID No. is requested when the input person makes a call, so that an inputted voice message and information are posted on the HP (see e.g. patent document 1).

[Patent Document 1] Japanese patent application laid-open No.2002-251360

As mentioned above, in the prior art example, it has been necessary for a service user to preliminarily and directly notify a transmitter (event notifier) such as a restaurant and a finder or a discoverer of his/her own individual information in some form, and there have been problems as follows:
1. Since it has been necessary to disclose individual information such as a mail address and a telephone No., and to have belongings and a child carry individual information, there has been a possibility that the individual information leaks and is used for purposes other than the original intent;
2. In terms of a individual information protection, the transmitter's management cost of a contact destination is increased; and
3. From the reason of the above-mentioned 1, the user refrains from sing a service for fear of an information leakage.

### SUMMARY OF THE INVENTION

It is accordingly an object of the present invention to provide a method and a device by which a service user can receive an event notifying message without disclosing a contact destination of the service user to a transmitter of the event notifying message.

⊚ A message proxy notifying method (and device) according to the present invention [1] comprises: a first step (and means) of holding a combination of a message ID acquired from a message receiver having received from a proxy request device an offering of the message ID using a unique code or symbol by which a destination can not be specified and contact information of the message receiver; and a second step (and means) of transmitting an event notifying message corresponding to the message ID to a message receiver of the contact information having the combination with the message ID when the message ID is received from the proxy request device, with an occurrence of an event.

Hereinafter, the present invention [1] will be described referring to FIG. 1.

Firstly, supposing that a proxy server (message proxy notifying device) 1 where a server operator is located has a message ID such as a two-dimensional bar code (QR code) or a wireless tag as an identifier for identifying various event notifying messages, the message ID is provided from the proxy server 1 to a proxy request device 2 where event notifier is located by an HTTP or the like (at steps S1 and S2). Since this is not an essential operation, it is indicated by a dotted line in FIG. 1.

It is to be noted that this message ID uses a unique code or symbol by which a destination can not be specified, and when it is prepared in the proxy request device 2, it is not necessary to perform the above-mentioned steps S1 and S2.

Thereafter, at the first step, the message ID is provided to a service user from the proxy request device 2 when e.g. the service user located at a message receiver 3 comes to a shop of the proxy request device 2 for receiving a service (at step S3). Accordingly, the message receiver 3 acquires the message ID (at step S4).

The combination of the message ID thus acquired from the proxy request device 2 and contact information of the message receiver 3 itself (mail address or telephone No. combined with e.g. a two-dimensional bar code which is a message ID) is transmitted to the proxy server 1 by the HTTP, SMTP, or the like to be registered (at steps S5 and S6).

Since the message ID is likewise transmitted from the proxy request device 2 to the proxy server 1 by the HTTP, SMTP, or the like when an event such as (1) service completion or (2) service available occurs (at step S7), the message ID is to be acquired by the proxy server 1 (at steps S8 and S9).

In the proxy server 1, when an event notifying message corresponding to the acquired message ID is registered in a database or the like, contact information such as a mail address of the message receiver 3 acquired at steps S5 and S6 is acquired together with the event notifying message corresponding to the message ID (at step S10), the event notifying message corresponding to the message ID is transmitted to the message receiver 3 of the contact information by the SMTP, POP, or the like (at step S11), and is received by the message receiver 3 (at step S12).

It is to be noted that when the proxy request device 2 holds the combination of the event notifying message and the message ID, the message ID and the message are transmitted at step S8, and the message corresponding to the message ID is further transferred to the receiver 3 of the contact information combined with the message ID.

Also, the message ID mentioned above may include a plurality of message IDs, and the combination of the same or a specific event notifying message corresponding to each of the message IDs may be preliminarily stored in the proxy server 1 or the proxy request device 2.

Thus, it becomes possible for the event notifier in the proxy request device 2 which requests a proxy of the event notification to transmit the event notifying message through the proxy server 1 in a form of anonymity without recognizing a mail address or the like of the message receiver 3 of the service user.

⊚ A message proxy notifying method (and device) according to the present invention [2] comprises: a first step (and means) of holding a combination of a message ID acquired from a message receiver having received an offering of the message ID using a unique code or symbol by which a destination can not be specified and contact information of the message receiver; and a second step (and means) of transmitting an event notifying message corresponding to the message ID to a message receiver of the contact information having the combination with the message ID when the message ID is received from a proxy request device having acquired the message ID from the message receiver, with an occurrence of an event.

Hereinafter, the present invention [2] will be described referring to FIG. 2.

The present invention [2] is different from the present invention [1] shown in FIG. 1 at steps S13-S15 as shown in FIG. 2. Namely, the message ID acquisition (at step S4) in the message receiver 3 is not from the proxy request device 2 as shown in the present invention [1] of FIG. 1, but from the proxy server 1 in which the server operator (system operator) exists (at step S13).

Thereafter, at steps S5 and S6, the contact information (mail address) of the message receiver 3 is transmitted to the proxy server 1 with the message ID acquired, to be registered (at step S6). However, in the message receiver 3, the message ID acquired is further provided to the proxy request device 2 by the service user (at step S14), so that the proxy request device 2 acquires the message ID (at step S15). This corresponds to a case where the service user of the message receiver 3 comes to a shop of the proxy request device 2 and hands over the message ID.

Thereafter, by performing steps S7-S12 in the same way as the above-mentioned present invention [1], it becomes possible for the event notifier in the proxy request device 2 who requests a proxy of the event notification to transmit the event notifying message through the proxy server 1 in a form of anonymity without recognizing a mail address or the like of the message receiver 3 of the service user.

⊚ A message proxy notifying method (and device) according to the present invention [3] comprises: a first step (and means) of holding a combination of a message ID acquired from a message receiver having received an offering of the message ID using a unique code or symbol by which a destination can not be specified and contact information of the message receiver; and a second step (and means) of transmitting an event notifying message corresponding to the message ID to a message receiver of the contact information having the combination with the message ID when the message ID is received from a proxy request device having read the message ID attached to a human body or an object.

Hereinafter, the present invention [3] will be described referring to FIG. 3.

As for the difference between the present invention [3] and the present invention [2] shown in FIG. 2, while the case is supposed in the present invention [2] where the service user of the message receiver 3 moves to the proxy request device 2 at steps S14 and S15, the case is supposed (at step S17) in the present invention [3] where the service user in the message receiver 3 attaches the message ID to his/her belongings or a human body (child) (at step S16), and an object to which the message ID is attached is found e.g. as a lost article in the proxy request device (contact place) 2 and the message ID is read by the proxy request device 2.

Namely, when the message ID is attached to the human body or the object at step S16, and a lost child or a lost article comes to the proxy request device 2, it becomes possible for the event notifier of the proxy request device 2 to transmit a necessary event notifying message without recognizing any contact information of a service request person in the message receiver 3.

According to the present invention, it is advantageous that when a user has been kept waiting in a restaurant or the like and a service is now available, when a termination of the waiting state is notified to the user, or when a lost article is found and the finding is notified to an owner, a service user can receive the event notifying message without notifying contact information to a transmitter of the event notifying to message, and even if the message ID is transferred to a third party, individual information can not be specified.

### BRIEF DESCRIPTION OF THE DRAWINGS

The above and other objects and advantages of the invention will be apparent upon consideration of the following detailed description, taken in conjunction with the accompanying drawings, in which the reference numerals refer to like parts throughout and in which:

FIG. 1 is a sequence diagram showing a summary of a message proxy notifying method and device according to the present invention [1];

FIG. 2 is a sequence diagram showing a summary of a message proxy notifying method and device according to the present invention [2];

FIG. 3 is a sequence diagram showing a summary of a message proxy notifying method and device according to the present invention [3];

FIG. 4 is a diagram showing an overall operational embodiment of a message proxy notifying method and device according to the present invention;

FIG. 5 is a block diagram showing an arrangement of a proxy server used for a message proxy notifying method and device according to the present invention;

FIG. 6 is a block diagram showing an arrangement of a proxy request device used for a message proxy notifying method and device according to the present invention;

FIG. 7 is a flowchart showing an example of an initial registration procedure between a proxy server and a proxy request device in a message proxy notifying method and device according to the present invention;

FIG. 8 is a flowchart showing an example of an ID information registration procedure from a receiver to a proxy server in a message proxy notifying method and device according to the present invention;

FIG. 9 is a flowchart showing an example of an ID transmission procedure from a proxy request device to a proxy server in a message proxy notifying method and device according to the present invention; and

FIG. 10 is a flowchart showing an example of a message transmission procedure from a proxy server to a receiver in a message proxy notifying method and device according to the present invention.

### DESCRIPTION OF THE EMBODIMENTS

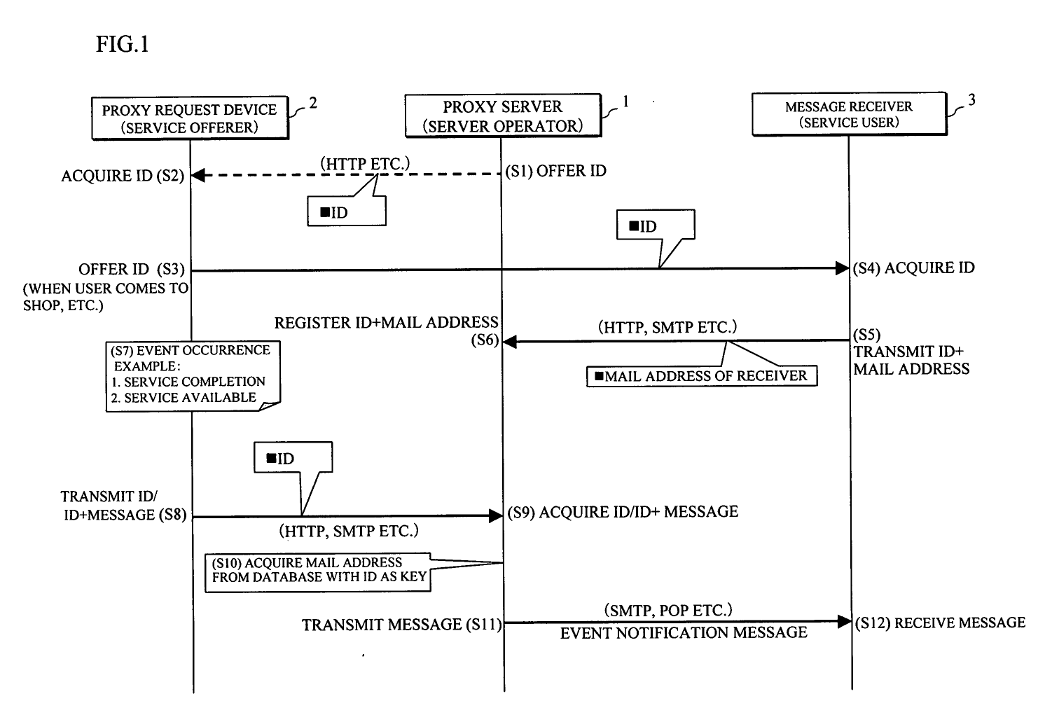

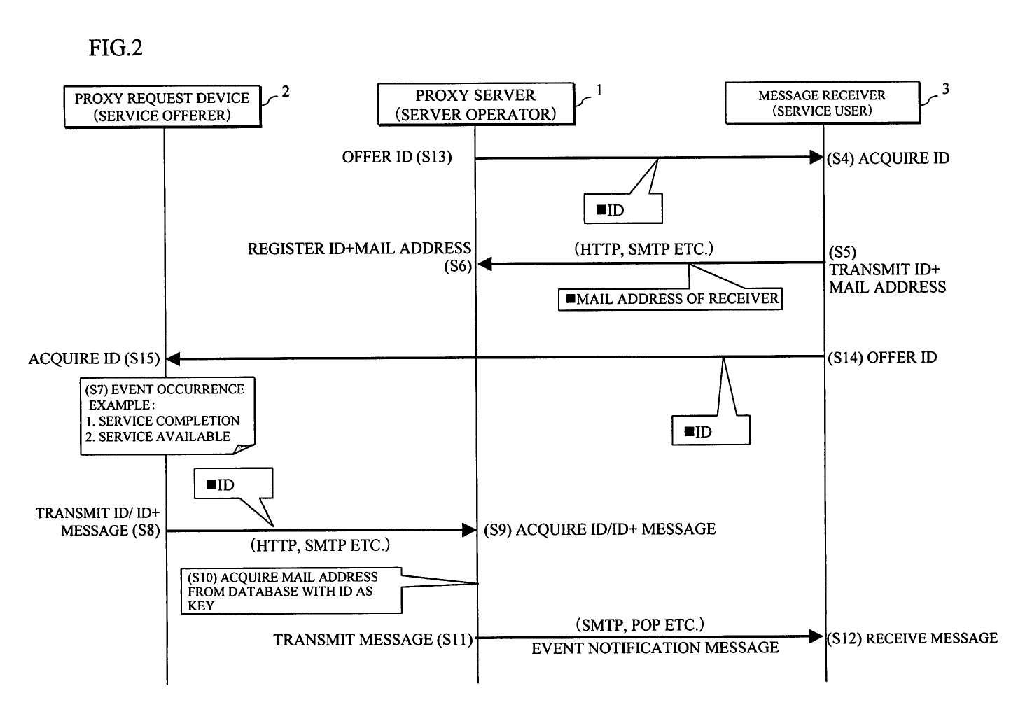

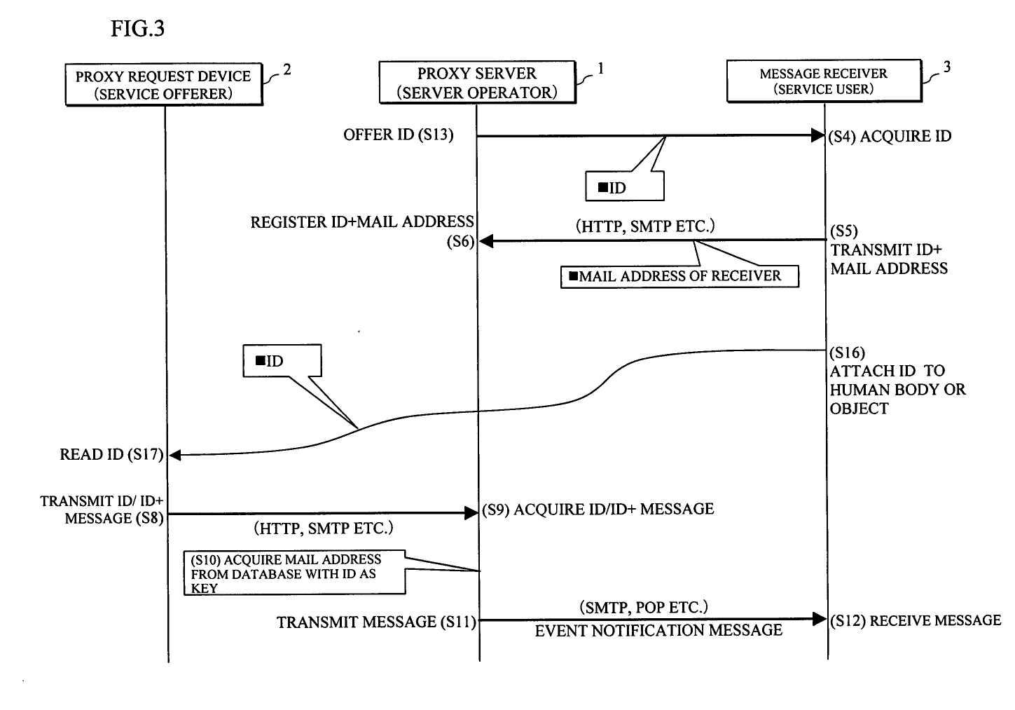

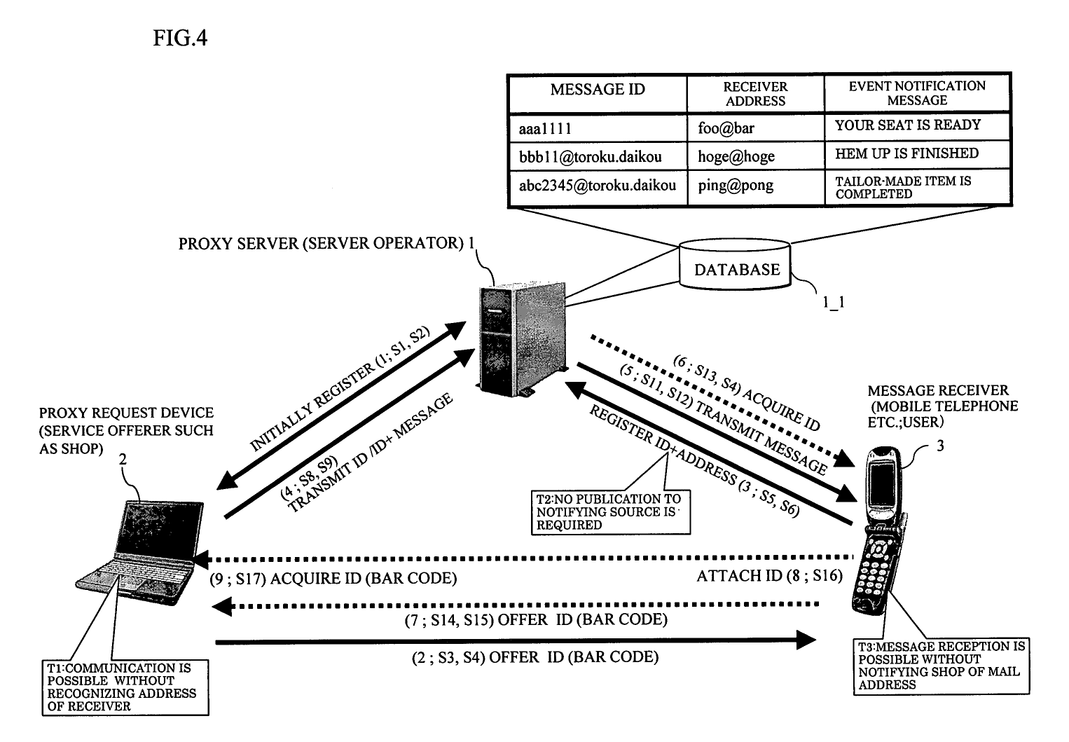

FIG. 4 shows an operation example in which the present inventions [1]-[3] shown in FIGS. 1-3 are integrated. Accordingly, the same reference numeral is indicated for the same step. Parts indicated by dotted lines specifically indicate an operation example of the present inventions [2] and [3]. Also, in the entirety of FIG. 4, it is indicated that an initial registration (1) is performed between the proxy server 1 and the proxy request device 2.

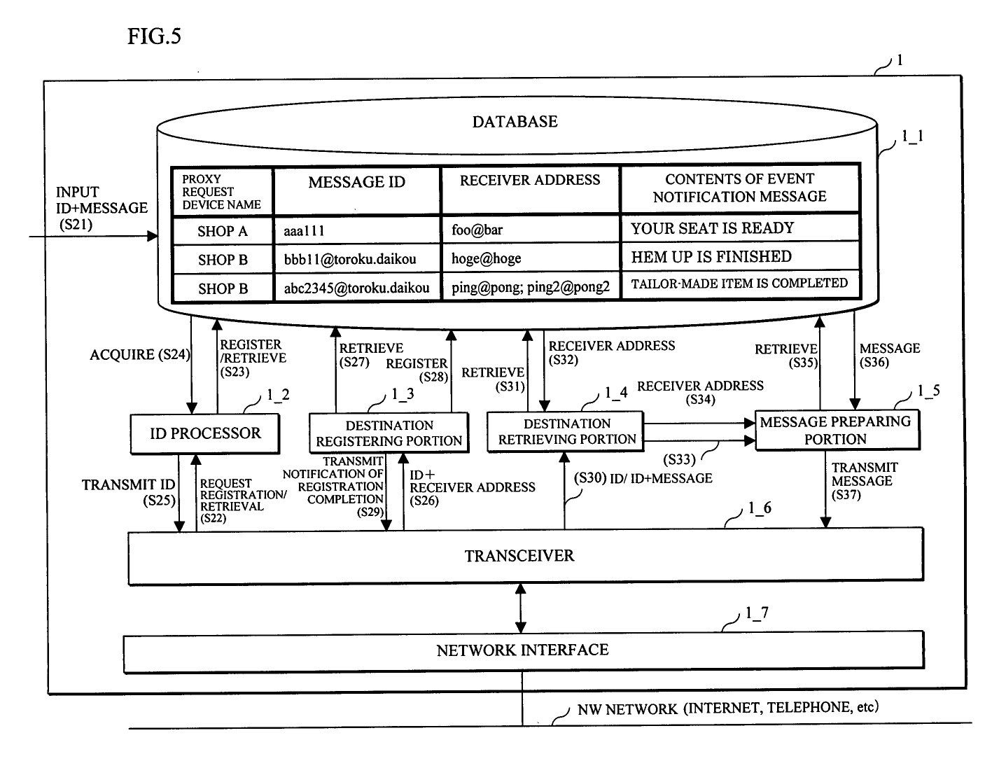

FIG. 5 shows an arrangement embodiment of the proxy server 1 shown in FIG. 4. In this embodiment, the proxy server 1 is provided with a database 1_1. The database 1_1, as shown in FIG. 5, is composed of a shop name of the proxy request device 2, the message ID, the mail address of the receiver 3, and the event notifying message. As shown in FIG. 5, it is possible to register different message IDs for the same shop. It is also possible to register different receiver addresses for the same message ID. Also, while event notifying messages with different message IDs are registered, it is possible to register event notifying messages with the same contents. It is to be noted that as for the database 1_1, as will be described later, the event notifying message is provided to the proxy request device 2 corresponding to each message ID in some cases, where the event notifying message is not required in the database 1_1.

The database 1_1 is connected to an ID processor 1_2, a destination registering portion 1_3, a destination retrieving portion 1_4, and a message preparing portion 1_5, and is connected therethrough to a network NW from a transceiver 1_6 and a network 1_7.

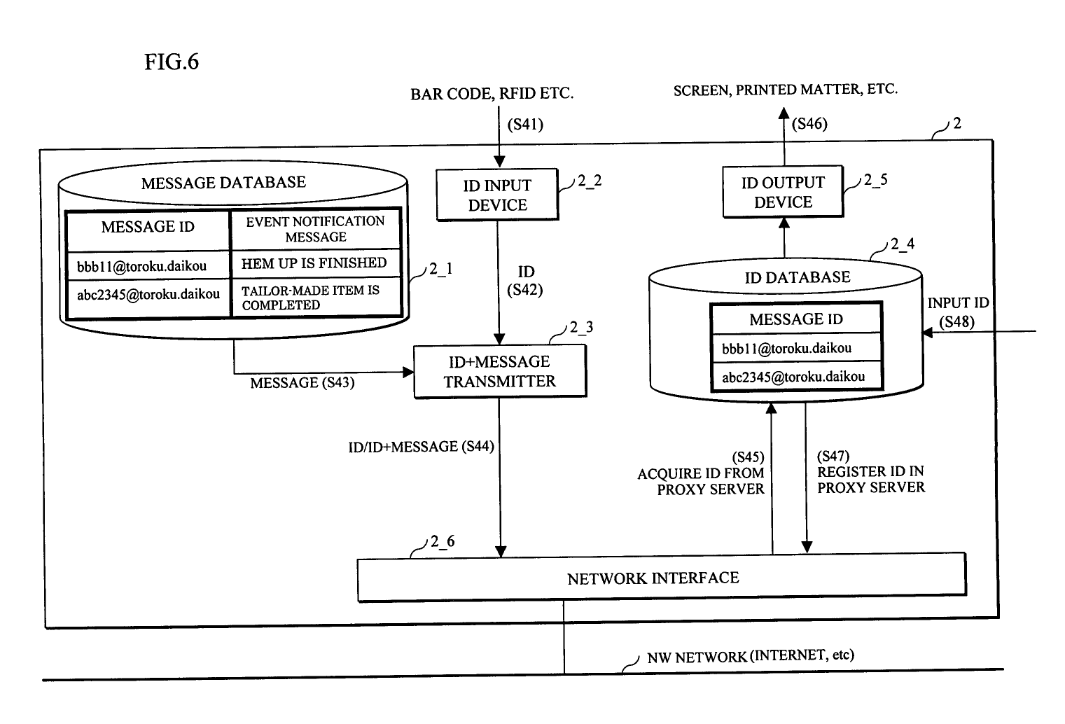

FIG. 6 shows an arrangement embodiment of the proxy request device 2 shown in FIG. 4. In this embodiment, the proxy request device 2 is composed of a message database 2_1, an ID input device 2_2 reading a recording medium such as a two-dimensional bar code or a wireless tag (RFID), an ID+message transmitter 2_3 connected to the message database 2_1 and the ID input device 2_2, an ID output device 2_5 outputting the message ID as a screen or a printed matter, an ID database 2_4, and a network interface 2_6 connecting the ID+message transmitter 2_3 and the ID database 2_4 to the network NW.

Namely, the proxy request device 2 compiles the message ID acquired from the ID input device 2_2 reading a recording medium such as a bar code or an RFID as a message transmitted over the network NW, and the message is transmitted to the address of the proxy server 1 preliminarily provided by using the network NW to which the proxy request device 2 is connected. It is to be noted that the ID input device 2_2 may be a function of the proxy request device 2_2, or may be another device connected to the proxy request device 2.

The proxy request device 2 has a function of accumulating the inputted message ID or the message ID acquired from the proxy server 1 in the ID database 2_4, and of displaying or handing the message ID to a user through the ID output device 2_5. When having an original message ID, the proxy request device 2 registers the message ID in the proxy server 1. The proxy request device 2 may have the message database 2_1 storing the message corresponding to the message ID, may transmit the message ID and the message corresponding to the message ID to the proxy server 1 triggered by the occurrence of the event, may dynamically generate a message by combining messages preliminary stored according to an event occurrence time and an event type to be transmitted together with the message ID, or may transmit only the message ID. When only the message ID is transmitted, the message corresponding to the message ID is preliminary registered in the database 1_1 of the proxy server 1. In any case, it is required to preliminary register the combination of the message ID and the event notifying message in either database of the proxy server 1 or the proxy request device 2. Accordingly, the event notifier of the proxy request device 2 and the service user of the receiver 3 may form a member of the service operator of the proxy server 1.

It is to be noted that when the event notifying message is registered in the database 1_1 of the proxy server 1 as shown in FIG. 5 in the proxy request device 2 shown in FIG. 6, the message database 2_1 is not required. Also, the ID input device 2_2 may be another device connected to the proxy request device 2.

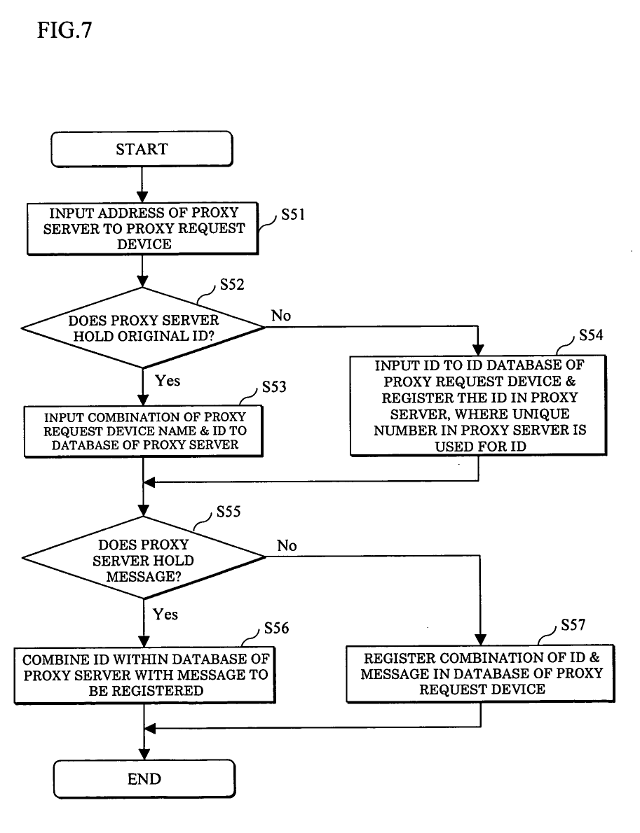

FIGS. 7-10 show various procedure examples of the embodiments of the present invention. The operation embodiments of the present inventions [1]-[3] will now be described referring to FIGS. 4-6 and FIGS. 7-10.

⊚Operation Embodiment of the Present Invention [1] (ID Handover→Registration→Preservation in Shop→Call-Out)

In this embodiment, as having been shown in FIG. 1, following procedures (1)-(5) are performed in which a recipient waiting for a service in a shop such as a restaurant or goods handover in a shop receives a notice of a termination of a service waiting state or a service completion from a transmitter by using the proxy server.

(1) A shop 2 offering some kind of service to a recipient 3 preliminarily receives a bar code as a message ID from an offerer 1 of a proxy event notifying service by a communication means such as the Internet and a printing medium such as paper.

(2) When the recipient 3 comes to the shop and the shop 2 keeps the recipient 3 waiting, the message ID (bar code) by which the recipient 3 can be uniquely identified is presented to the recipient 3 by using a printed matter, by word of mouth, or on a display, so that the recipient 3 receives the message ID. In this case, the transmitter 2 makes contact without recognizing the address of the recipient 3 (at step T1).

(3) The recipient 3 registers the mail address of the mobile telephone and the message ID as the receiver 3 by using a mobile telephone the recipient 3 possesses in the proxy server 1 by using the Web or a mail. In this case, the recipient 3 is not required to disclose the address to the transmitter 2 which is a notifying source (at step T2).

(4) When the shop 2 desires to notify the event that the service is available or the service is completed to the recipient 3 in the form of a message of a mail, the message ID corresponding to the recipient 3 is transmitted to the proxy server 1 by a TCP protocol or the like over the Internet.

(5) The proxy server 1 having received the message ID acquires the mail address from the message ID by using the database, makes a message having been prepared for the shop 2 requested, and transmits the message prepared to the address of the recipient (receiver) 3 by e-mail. In this case, it is possible to receive the event notifying message without notifying the transmitter 2 of the address (at step T3).

Thus, it becomes possible for the recipient 3 to receive the mail, and to recognize that the service is available or the service is completed at the shop 2 from the message.

The procedures of the above-mentioned (1)-(5) will now be described in more detail.

(1) Initial Registration (at Steps S1 and S2)

Firstly, as shown in FIG. 7, an address of the proxy server 1 is registered in the proxy request device 2 (at step S51), and communication to the proxy server 1 from the proxy request device 2 is enabled. Then, whether the original ID is held in either the proxy server 1 or the proxy request device 2 is determined (at step S52). According to the result, the message ID which forms an original ID is inputted to either device, so that the original message ID is stored in the database.

Namely, when the proxy request device 2 holds the original message ID in the ID database 2_4, the message ID which can be uniquely identified over the proxy server 1 is inputted to the ID database 2_4 of the proxy request device 2 (at step S48), and is registered in the database 1_1 of the proxy server 1 (at steps S54 and S47). The unique message ID may be formed by e.g. adding a character string specific to the proxy request device 2 preliminarily inputted to the proxy request device 2 to an arbitrarily character string generated by the proxy request device 2, or the proxy request device 2 itself may generate a sequential number space different per proxy request device 2.

When the proxy server 1 holds the original message ID in the database 1_1, the combination of a proxy request device name and the message ID is registered in the database 1_1 of the proxy server 1. It is to be noted that the database 1_1 may form a function of the proxy server 1, or a different server device that can be freely referred to or changed by the proxy server 1.

After thus registering the message ID, and when the ID processor 1_2 of the proxy server 1 shown in FIG. 5 is requested the acquisition of the message ID from the proxy request device 2 (or service user of the receiver 3) (at step S22 of FIG. 5), the message ID available is responded to a requesting person by referring to the database 1_1 (at steps S23-S25, S1, and S2). When the message ID is registered in the proxy server 1 from the proxy request device 2, the ID processor 1_2 executes the registration to the database 1_1 (at steps S22 and S23).

Also, the event notifying message notified to the user of the receiver 3 may be preliminarily registered in the database 1_1 of the proxy server 1 as the combination with the message ID (at steps S55 and S56), and also may be registered in the message database 2_1 of the proxy request device 2 as the combination with the message ID (at steps S55 and S57). In the latter case, the message ID and the message may be transmitted to the proxy server 1, or an appropriate message among the messages preliminary stored by the proxy request device 2 upon occurrence of an event is selected to be transmitted with the message ID to the proxy server 1.

The message ID from the proxy server 1 is registered in the ID database 2_4 of the proxy request device 2 (at step S45), and is outputted from the ID output device 2_5 in the form of a screen or a printed matter (at step S46). The message database 2_1 may form a function of the proxy server 1 or the proxy request device 2. Alternatively, the message database 2_1 may form a different server device that can be freely referred to or changed by the proxy server 1 or the proxy request device 2.

Thus, when the event notifying message is registered in the database 1_1 of the proxy server 1, the message database 2_1 of the proxy request device 2 shown in FIG. 6 becomes unnecessary. On the other hand, when the message database 2_1 is provided in the proxy request device 2, the event notifying message within the database 1_1 in the proxy server 1 becomes unnecessary.

(2) ID Offering (at Steps S3 and S4)

While the message ID is directly distributed/presented so that a QR code (two-dimensional bar code) generally known may be read by the service user or the message receiver 3 owned by the service user, it may be presented by e-mail or the like.

(3) ID+Address Registration (at Steps S5 and S6)

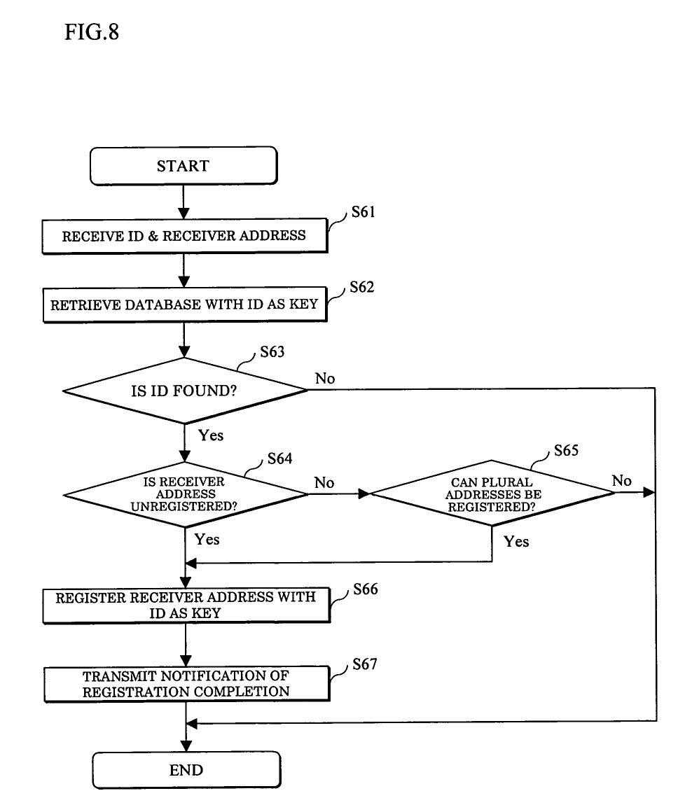

FIG. 8 shows a procedure of the ID+address registration. The message receiver 3 combines the message ID offered by the above-mentioned (2) with the mail address of the device itself, and transmits the combination to the proxy server 1 to be registered (at steps S5 and S6). It is to be noted that while this registration is basically executed by the request from the message receiver 3, a third party other than the message receiver 3 may register it. Also, as for the registration of this message ID and the mail address, if the above-mentioned QR code is used, the picture of the message ID is taken by an integral camera of the mobile telephone as the message receiver 3, the message ID is recognized, and then a predetermined procedure is executed, so that a mail address of one's own mobile telephone can be automatically transmitted to the proxy server 1.

Thus, in the proxy server 1 having received the message ID and the mail address (at steps S61 and S26), the destination registering portion 1_3 performs retrievals with the message ID of the database 1_1 as a key (at steps S62 and S27). As a result, only when the message ID from the message receiver 3 is found in the database 1_1 (at step S63), the process proceeds to step S64, and whether or not the address of the receiver 3 is registered is determined (at step S64). As a result, when the address of the receiver 3 is found as not registered, the address of the receiver 3 is registered with the message ID as a key (at steps S66 and S28).

Thus, an address “hoge@hoge” of the receiver 3 is registered for an address “bbb11@touroku.daikou” for e.g. a shop B. It is to be noted that when the address of the receiver 3 has been already registered, the registration in this case is also performed if a plurality of addresses can be registered (at steps S65, S66, and S28).

Thereafter, a registration completion notification is transmitted to the destination registering portion 1_3 (at steps S67 and S29). This registration completion notification is transmitted to the message receiver 3 through the transceiver 1_6 and the network interface 1_7. It is to be noted that the database 1_1 of the proxy server 1 may form a function of the proxy server 1 or a different server device that freely referred to or changed by the proxy server 1. Also, in the database 1_1, whether the message ID is one which can be newly registered or an effective message ID is checked (at step S27). When the message ID is found to be one which can not be registered, its registration may be refused.

(4) ID (or ID+message) Transmission (at Steps S8 and S9)

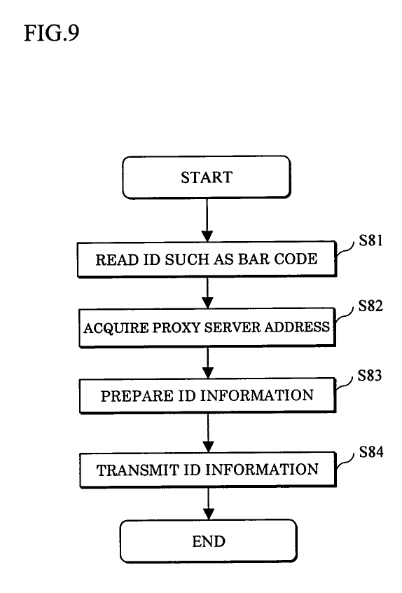

Before this procedure, as shown in FIGS. 1-3, an event occurrence (at step S7) is assumed. Namely, as shown in the transmission procedure in FIG. 9, when the message ID presented is transmitted in the above-mentioned (2), the proxy request device 2 acquires the address of the proxy server 1 (at step S82), prepares the ID information (at step S83), and transmits the ID information (at step S84).

In this case, when the event notifying message is stored in the database 1_1 of the proxy server 1, it is not required to transmit the event notifying message. However, when the message database 2_1 exists in the proxy request device 2, the ID+message transmitter 2_3 transmits the message ID such as a two-dimensional bar code or a wireless tag from the ID input device 2_2 and the message from the message database 2_1 (at steps S43 and S44).

(5) Event Notifying Message Transmission (at Steps S11 and S12)

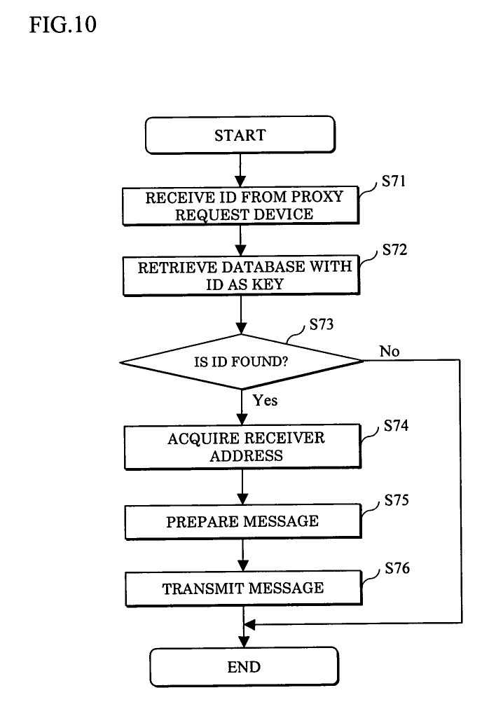

The procedure at this time is shown in FIG. 10. Namely, when the message ID is received from the proxy request device 2 by the above-mentioned (4) (at steps S71 and S30), the destination retrieving portion 1_4 in the proxy server 1 retrieves the database 1_1 with the message ID as a key (at steps S72 and S31). As a result, when the message ID is retrieved from the database 1_1 (at step S73), the destination retrieving portion 1_4 acquires the address of the receiver 3 from the database 1_1 (at steps S74 and S32) and further provides the ID (or ID+message) together with the address of the receiver 3 to the message preparing portion 1_5 (at steps S33 and S34).

The message preparing portion 1_5 retrieves the database 1_1 (at step S35), takes out the event notifying message “hem up is finished” corresponding to the ID=“bbb11@touroku.daikou” in the above example (at step S36), and prepares a message (at step S75), so that a message transmission is performed (at steps S76 and S37).

It is to be noted that when the proxy request device 2 has transmitted the message with the message ID, the received message may be transferred to the message receiver 3. In any case, the service user finally receives the event notifying message from the proxy server 1.

The above-mentioned procedures are in representative forms, to which procedures are not limited. For example, various modifications can be conceived as follows:

While the bar code is used as the message ID in the above-mentioned (1) and (2), an arbitrary bar code such as a two-dimensional bar code of a QR code may be used as mentioned above. Other than the bar code, a number and a character string which can be read by the recipient (receiver) 3, a telephone No. which can register the information of the recipient, voice which can be heard by the recipient (receiver) 3, a noncontact/contact communication means such as a wireless tag (RFID) which can be received by the receiver 3 may be used to be transmitted to the recipient (receiver) 3.

In the above-mentioned (3), an example is indicated in which the recipient 3 inputs a mail address at a site indicated by a registering URL different per recipient 3, or the recipient inputs information from a Web page where the message ID and the mail address of the recipient are inputted as a form on the Web displayed by the URL common to the recipient. As another example, by using an address of a blank mail (having no body or subject, composed of only a destination of the mail and transmitter information) by which the recipient 3 for a recipient registration indicated by e.g. a bar code as the message ID, the trouble of inputting an address of a registering destination and the address of the device itself with keys by using a communication means and registering the addresses in the proxy server becomes unnecessary for the recipient 3 as long as the receiver 3 has a bar code reader. In this case, a code including a mail address for registration different per recipient 3 may be generated as the bar code information. Alternatively, a bar code in which the address for registration is common and ID information different per recipient 3 is incorporated into the bar code information designated by the subject and the body may be generated. Also, when the bar code is not used, data indicating an arbitrary communication means and by which a destination address of the recipient such as a mail address, a URL, or a telephone No. can be registered may be transmitted to the recipient (receiver) 3 from the transmitter 2 by using the noncontact/contact communication means.

Also, whether or not the ID information transmitted is valid may be checked in the database. A registration request to the message ID whose destination address has been already registered, for example, may be refused. Alternatively, information such as an IP address, a mail address and a telephone No. of the recipient (receiver) 3 which is a request source having requested the registration in the database may be used so as to allow only a registration from the receiver 3 allowed.

Furthermore, when the message ID includes an expiration date, or when the message ID has the expiration date such that the expiration date is stored in the ID database, the registration may be allowed within the expiration date.

While the TCP protocol is used over the Internet in the above-mentioned (4), any protocol substituting for the TCP protocol or a communication means such as a telephone may be used.

In the above-mentioned (5), a message may be notified by using an arbitrary protocol and communication means from the proxy server 1 to the recipient 3. For example, the message may be notified by a telephone by voice, or a protocol such as http or SIP may be used over the Internet.

⊚Operation embodiment of the present invention [2] (ID handover→registration→preservation in person ID presentation by coming to shop→call-out)

(6) ID acquisition (steps S13 and S14)

While the transmitter 2 hands over the message ID to the recipient 3 in the embodiment of the above-mentioned present invention [1], in this embodiment, the recipient 3 provides the message ID (bar code etc.) to the transmitter 2, thereby saving the labor and costs of acquiring the message ID by the transmitter 2 (at steps S13 and S14).

The recipient 3 preliminarily receives the bar code as the message ID from a proxy 1 of the event notifying service by the communication means such as the Internet and a printed medium such as paper (at steps S14 and S15).

(7) ID offering (at steps S14 and S15)

Then, the recipient 3 registers the mail address corresponding to the message ID. When going to the shop 2, the recipient 3 indicates the message ID to the shop 2. At this time, the shop 2 reads the message ID to identify which proxy server 1 the message ID is to be transmitted.

Other procedures are the same as the above-mentioned (1)-(5).

⊚Operation embodiment of the present invention [3] (lost article case: ID handover→registration→preservation in person→detachment from his/her hand→call-out)

(8) ID attachment (at step S16)

While in the embodiment of the above-mentioned present invention [2], the recipient 3 explicitly presents the message ID (bar code etc.) to the transmitter 2 in the procedure (7), in this embodiment, the message ID is attached to the belongings of the recipient 3 or to an accompanying person such as a child of the recipient 3 in the procedure (7).

(9) ID Acquisition (at Step S17)

It is then supposed that when an object or person to which the message ID is attached comes free from the supervision of the recipient 3 and is lost, the object or person having the message ID attached is found by a railway, a bus, public facilities, a shop or the like. At this time, the transmitter 2 obtains the message ID, and transmits the message ID to the proxy server 1 preliminary known, thereby enabling the mail with the message to be transmitted to the recipient 3 in the same way as the above-mentioned embodiment.

Also, a URL of the proxy server, a mail address, information specifying a lost item and its owner may be preliminarily incorporated into the message ID with a symbol so that a third party may directly notify thorough the proxy server 1.

What is claimed is:

1. A message proxy notifying method comprising:
a first step of holding a combination of a message ID acquired from a message receiver having received from a proxy request device an offering of the message ID using a unique code or symbol by which a destination can not be specified and contact information of the message receiver; and
a second step of transmitting an event notifying message corresponding to the message ID to a message receiver of the contact information having the combination with the message ID when the message ID is received from the proxy request device, with an occurrence of an event.

2. A message proxy notifying method comprising:
a first step of holding a combination of a message ID acquired from a message receiver having received an offering of the message ID using a unique code or symbol by which a destination can not be specified and contact information of the message receiver; and
a second step of transmitting an event notifying message corresponding to the message ID to a message receiver of the contact information having the combination with the message ID when the message ID is received from a proxy request device having acquired the message ID from the message receiver, with an occurrence of an event.

3. A message proxy notifying method comprising:
a first step of holding a combination of a message ID acquired from a message receiver having received an offering of the message ID using a unique code or symbol by which a destination can not be specified and contact information of the message receiver; and
a second step of transmitting an event notifying message corresponding to the message ID to a message receiver of the contact information having the combination with the message ID when the message ID is received from a proxy request device having read the message ID attached to a human body or an object.

4. The message proxy notifying method as claimed in claim 1, further comprising a step of offering the message ID to the proxy request device.

5. The message proxy notifying method as claimed in claim 2, further comprising a step of offering the message ID to the receiver.

6. The message proxy notifying method as claimed in claim 1, further comprising a step of preliminarily storing a combination of a plurality of message IDs and a same or a specific event notifying message corresponding to each of the message IDs.

7. The message proxy notifying method as claimed in claim 1, wherein the proxy request device further includes a step of preliminarily storing a combination of a plurality of message IDs and a same or a specific event notifying message corresponding to each of the message IDs, and the second step includes a step of receiving the message with the message ID from the proxy request device.

8. The message proxy notifying method as claimed in claim 1, wherein the message ID comprises a two-dimensional bar code or a wireless tag.

9. The message proxy notifying method as claimed in claim 1, wherein the contact information comprises a mail address or a telephone number having the combination with a two-dimensional bar code that is the message ID.

10. A message proxy notifying device comprising:
a first means holding a combination of a message ID acquired from a message receiver having received from a proxy request device an offering of the message ID using a unique code or symbol by which a destination can not be specified and contact information of the message receiver; and
a second means transmitting an event notifying message corresponding to the message ID to a message receiver of the contact information having the combination with the message ID when the message ID is received from the proxy request device, with an occurrence of an event.

11. A message proxy notifying device comprising:
a first means holding a combination of a message ID acquired from a message receiver having received an offering of the message ID using a unique code or symbol by which a destination can not be specified and contact information of the message receiver; and
a second means transmitting an event notifying message corresponding to the message ID to a message receiver of the contact information having the combination with the message ID when the message ID is received from a proxy request device having acquired the message ID from the message receiver, with an occurrence of an event.

12. A message proxy notifying device comprising:
a first means holding a combination of a message ID acquired from a message receiver having received an offering of the message ID using a unique code or symbol by which a destination can not be specified and contact information of the message receiver; and
a second means transmitting an event notifying message corresponding to the message ID to a message receiver of the contact information having the combination with the message ID when the message ID is received from a proxy request device having read the message ID attached to a human body or an object.

13. The message proxy notifying device as claimed in claim 10, further comprising a means offering the message ID to the proxy request device.

14. The message proxy notifying device as claimed in claim 11, further comprising a means offering the message ID to the message receiver.

15. The message proxy notifying device as claimed in claim 10, further comprising a means preliminarily storing a combination of a plurality of message IDs and a same or a specific event notifying message corresponding to each of the message IDs.

16. The message proxy notifying device as claimed in claim 10, wherein the proxy request device further includes a means preliminarily storing a combination of a plurality of message IDs and a same or a specific event notifying message corresponding to each of the message IDs, and the second means includes a means receiving the message with the message ID from the proxy request device.

17. The message proxy notifying device as claimed in claim 10, wherein the message ID comprises a two-dimensional bar code or a wireless tag.

18. The message proxy notifying device as claimed in claim 10, wherein the contact information comprises a two-dimensional bar code, a mail address, or a telephone number having the combination with the message ID.
